(19) United States
(12) Patent Application Publication
(10) Pub. No.: US 2004/0212367 A1
(43) Pub. Date: Oct. 28, 2004

(54) Battery characterization system

(76) Inventor: Thomas J. Dougherty, Waukesha, WI (US)

Correspondence Address: FOLEY & LARDNER, 777 EAST WISCONSIN AVENUE, SUITE 3800, MILWAUKEE, WI, 53202-5308, US

(21) Appl. No.: 10/481,657

(22) PCT Filed: Jun. 21, 2002
(86) PCT No.: PCT/US02/19760

Related U.S. Application Data
(60) Provisional application No. 60/300,603, filed on Jun. 22, 2001.

(51) Int. Cl. G01N 27/416

(52) U.S. Cl. 324/426

(57) ABSTRACT

A system for modeling a lead-acid battery is disclosed. A system for modeling a lead-acid battery is also disclosed. An equivalent circuit model of a battery comprising an impedance circuit for simulating the electrochemical charging and discharging of the battery is also disclosed. A circuit (100) for modeling a lead-acid battery having an RC network for simulating the impedance of cells of the battery is also disclosed. A method of modeling a lead-acid battery with an electrical circuit (100) comprising a charging circuit (111), an electrochemical reaction circuit (113), and a voltage drop circuit (115) is also disclosed. A method for constructing an equivalent electrical circuit model of a lead-acid battery is also disclosed.

### CROSS-REFERENCE TO RELATED APPLICATIONS

The following U.S. patents and/or patent applications are hereby incorporated by reference: U.S. Provisional Patent Application No. 60/300,603 titled “BATTERY CHARACTERIZATION SYSTEM AND METHOD” filed Jun. 22, 2001 and U.S. patent application Ser. No. 10/007,320 titled “BATTERY MONITORING SYSTEM AND METHOD” filed Oct. 22, 2001.

This application claims priority to U.S. Provisional Patent Application No. 60/300,603 titled “BATTERY CHARACTERIZATION SYSTEM AND METHOD” filed Jun. 22, 2001.

### FIELD

The present invention relates to a battery characterization system and method. More particularly, the present invention relates to a simulation circuit for characterizing and simulating the operation of batteries, including lead acid batteries, under various operating conditions.

### BACKGROUND

Typically, lead-acid batteries are rated in terms of “amp hours.” Lead acid batteries, and charge storage devices of all types, however, are manufactured in accordance with a variety of product standards, and therefore the internal chemical and mechanical constructions of batteries can be very different. Consequently, batteries with similar amp hour ratings can provide a variety of performance levels, particularly in terms of the amount of power or energy which they can provide. Even batteries which appear to be “drop-in” replacements for each other by the amp hour standard can behave differently when in actual use.

It is generally known to model batteries using an equivalent circuit model. Such known model typically includes the equivalent circuit of a battery made up of a constant voltage source and series resistors without consideration of the variation of discharge voltage over time. However, such model works only for a short period of discharge time under a DC current, and may be insufficient for modeling the dynamic characteristics of a battery.

Another known battery model uses the “Peukert” parameter. However, such model does not provide a sufficiently accurate equivalent circuit of a battery because such model approximates the discharge profile linearly at the initial stage of discharge and exponentially at the late stage of discharge. Therefore, such model does not closely approximate the actual discharge of a lead-acid battery.

Another known battery model includes modeling the discharge voltage and internal resistance of the battery for the case of a long DC discharge. However, such known model does not necessarily accurately model the characteristics of the battery under transient conditions of discharge.

Another known battery model is based on an RC network, and generally models a battery in the same manner as a transmission line. However, such known model does not necessarily accurately model the relative state of charge versus open circuit voltage for intensive simulation applications.

Accordingly, it would be advantageous to provide a means for characterizing the operational performance of batteries. It would also be advantageous to provide an equivalent circuit of a battery which models the dynamic performance characteristics of a lead-acid battery. It would also be advantageous to provide an equivalent circuit which can be used to model the performance of a battery in a vehicle. It would be desirable to provide for a battery characterization system and method having one or more of these or other advantageous features.

### SUMMARY OF THE INVENTION

The present invention relates to a system for modeling a lead-acid battery.

The present invention also relates to an equivalent circuit model of a battery comprising an impedance circuit for simulating the electrochemical charging and discharging of the battery.

The present invention also relates to a circuit for modeling a lead-acid battery having an RC network for simulating the impedance of cells of the battery.

The present invention also relates to a method of modeling a lead-acid battery with an electrical circuit comprising a charging circuit, an electrochemical reaction circuit, and a voltage drop circuit.

The present invention also relates to a method for constructing an equivalent electrical circuit model of a lead-acid battery.

### DESCRIPTION OF THE FIGURES

FIG. 1 is a block diagram of a system for characterizing a battery according to an exemplary embodiment.

FIG. 2 is a graph showing a resistance of a battery according to an exemplary embodiment.

FIG. 3 is a graph showing an ionic/electronic resistance ratio of a battery according to an exemplary embodiment.

FIG. 4A is a graph showing voltage drop versus current of a battery according to an exemplary embodiment.

FIG. 4B is a graph showing a logarithm of voltage versus current of a battery according to an exemplary embodiment.

FIG. 5 is a graph showing Peukert's equation according to an exemplary embodiment.

FIG. 6 is a graph showing open circuit voltage versus relative state of charge for a number of battery acid level conditions according to an exemplary embodiment.

FIG. 7A is a block diagram showing a circuit for simulating a battery according to a preferred embodiment.

FIG. 7B is a circuit diagram showing the circuit of FIG. 7A for simulating a battery according to a preferred embodiment.

FIG. 8 is a chart showing the arrangement of data for characterizing batteries according to an exemplary embodiment.

### DETAILED DESCRIPTION OF PREFERRED AND OTHER EXEMPLARY EMBODIMENTS

In order to select a battery appropriate for the requirements of a particular application, many factors (e.g., battery parameters and characteristics such as voltage, current capacity, internal resistance, etc.) could be considered. Certain battery characterization parameters are quantified (e.g., given by a manufacturer, determined experimentally, etc.). A control system performs a control program (e.g., transfer function) on these parameters to provide an “equivalent” electrical circuit or model of the battery. The transfer function provides output related to the type of components for the electrical circuit model (e.g., particle capacitors, resistors, MOSFETS, etc.). The model simulates how the battery will perform under certain conditions (e.g., charging, discharging, etc.). The model is useful for determining the appropriate battery for a given application, and for maximizing performance of the battery in a selected application (e.g., hybrid electric vehicle).

One method for verifying that a battery is appropriate for a selected purpose is through simulation modeling. Simulation models may be used for hardware modeling of systems, and also for software simulations and SPICE models. Equivalent circuit models can be used for applications such as automobiles, in which lead acid batteries are subject to a large variety of operating conditions and environmental factors.

The battery characterization parameters provide information for the transfer function, which simulates the internal resistance, the current characteristics, and the voltage characteristics of the battery to provide a simulation of the actual battery being modeled. The circuit can be used to model “deliverable power” of the circuit (e.g., a calculated representation (typically reported in kilowatts) of the amount of power that can be drawn from a battery at a given discharge wattage at a specified voltage or at a given current to a specified voltage and which takes into consideration the internal resistance of the battery). The circuit can also be used to model deliverable energy of the circuit (e.g., usable energy over time (reported in kilowatt/hours), a calculated representation of the average amount of deliverable power that is available over time at a given discharge wattage at a specified voltage or at a given current to a specified voltage).

The battery resistance may be modeled to account for a number of physical and chemical parameters of a specific battery, and therefore to account for differences in construction of the battery. A number of tests are performed on the battery to characterize each of the following resistance values: an internal DC resistance, an ionic resistance, an electronic resistance, and a kinetic resistance. One set of tests is performed to determine the current charging and discharging characteristics of the circuit model to characterize the nominal capacity and Peukert's slope of the battery. Another set of tests is performed to characterize the voltage capacity of the battery and the slope of the open circuit voltage versus the state of charge. Based on the data collected from these tests (and additional characterizing data supplied by the battery manufacturer) a circuit is constructed to simulate the performance of the battery. The reaction of the battery to varying temperature conditions may also characterized through a test procedure.

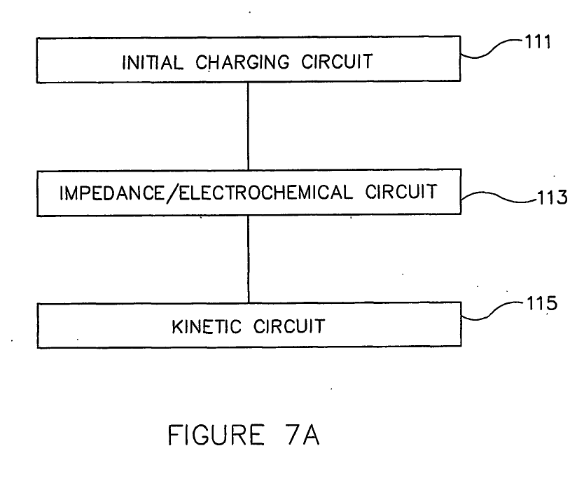

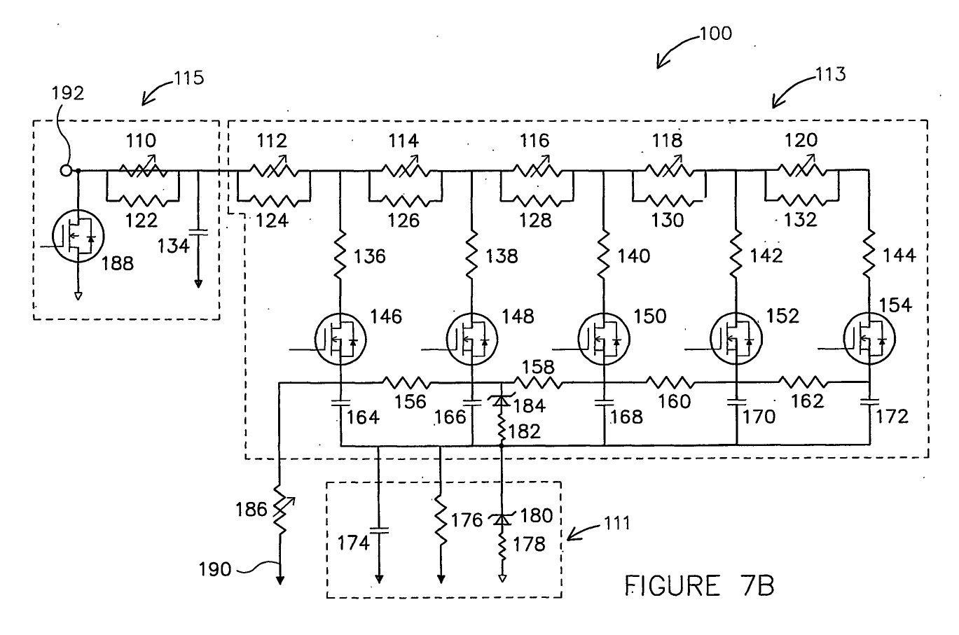

Based on the characterizing parameters determined from these tests, a circuit that models a battery is constructed (see FIG. 7B). The circuit includes a series of resistive and capacitive elements designed to “mimic” or simulate the dynamic response of the battery being modeled. The characteristics of the battery derived from the test data can also be used in a universal product code for labeling the battery, and also for storage in a memory component which can be accessed by intelligent controllers accessing the battery.

The tests provide battery characterizing data to construct a circuit exhibiting a transfer function modeling the operation of the battery (e.g., lead-acid battery or other electrical storage device). Once the characterizing data is obtained, the data also can be used to construct a “universal” battery product code which uniquely characterizes the battery. The universal battery product code can be used to label the product, thereby providing information about the battery to a user (e.g., consumer selecting a battery for a particular purpose, technician, warranty reviewer, etc.). The code can also be stored in memory for use by “intelligent” controllers coupled to the battery (e.g., in an automobile or other vehicle). The following discussion relates to tests and construction data to characterize the battery, the resultant simulation circuit, and an example of a product code labeling procedure.

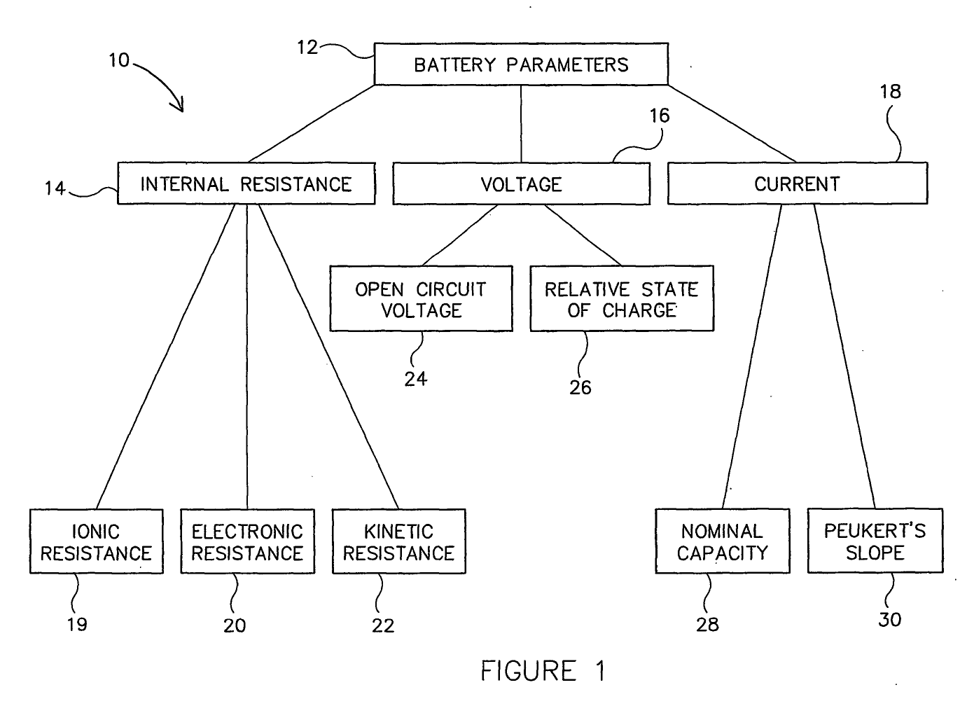

Battery testing and characterization includes establishing (e.g., experimentally) a number of parameters for a battery. Referring to FIG. 1, a system 10 for determining battery parameters 12 of a battery is shown. Parameters 12 include an internal resistance 14, a voltage 16, and a current 18 of the battery. Parameters 12 may be known (e.g., provided by the battery manufacturer), obtained through a series of tests, etc.

The resistance parameters of the battery are determined through tests. At least three resistance tests may be performed: (1) an internal resistance test to determine total internal resistance 16; (2) an ionic/electronic resistance test to determine ionic resistance 19 and electronic resistance 20; and a reaction kinetics test to determine kinetic resistance 22 (see FIG. 1).

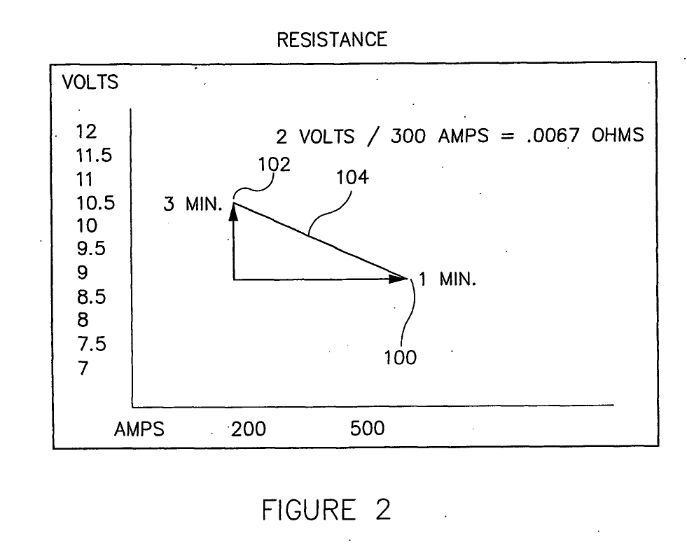

Referring to FIG. 2, a graph illustrating the measurement of internal DC resistance in a charged and conditioned lead-acid battery is shown. The internal resistance test is run at 25 degrees C. To characterize the total internal resistance for a given battery, the battery is initially discharged for three seconds at the one minute rate (e.g., the rate at which the battery supplies current and still maintains a predetermined voltage such as 7.2 volts). The current and voltage of the battery is calculated after three seconds, and this point is plotted (shown as the one minute resistance 100). Next, the battery is discharged at the three minute rate, and the current and voltage is again calculated after three seconds. The voltage versus current at the three minute rate (shown as 3 minute resistance 102) is also plotted on a voltage versus current curve (see FIG. 2). The total internal resistance (shown as resistance 104) of the battery is calculated as the slope of the line between the one minute resistance 100 and the three minute resistance 102 as the value of change in voltage versus change in current (dv/di). This resistance value is modeled in a circuit by a plurality of resistors according to a preferred embodiment (see FIG. 7B).

The total internal resistance 104 relates to the sum of two types of resistance in the battery: the ionic resistance 19 and the electronic resistance 20. Therefore, the experimentally determined total internal resistance may be characterized as a separate component. The “ionic resistance” relates to a chemical component of the resistance based on the acid in the battery. The “electronic resistance” relates to the resistance of the solid conductive materials in the battery. The ionic and electronic components of the resistance may react differently to time and temperature and may therefore be modeled as separate components. The ionic component is preferably modeled as a negative temperature coefficient resistance, because the resistance of the chemical component decreases as the temperature increases. The electronic component can be a standard resistor, but can also be modeled as a positive temperature coefficient resistor, depending on the materials used to construct the battery (see FIG. 7B). Generally, the electronic component increases with temperature.

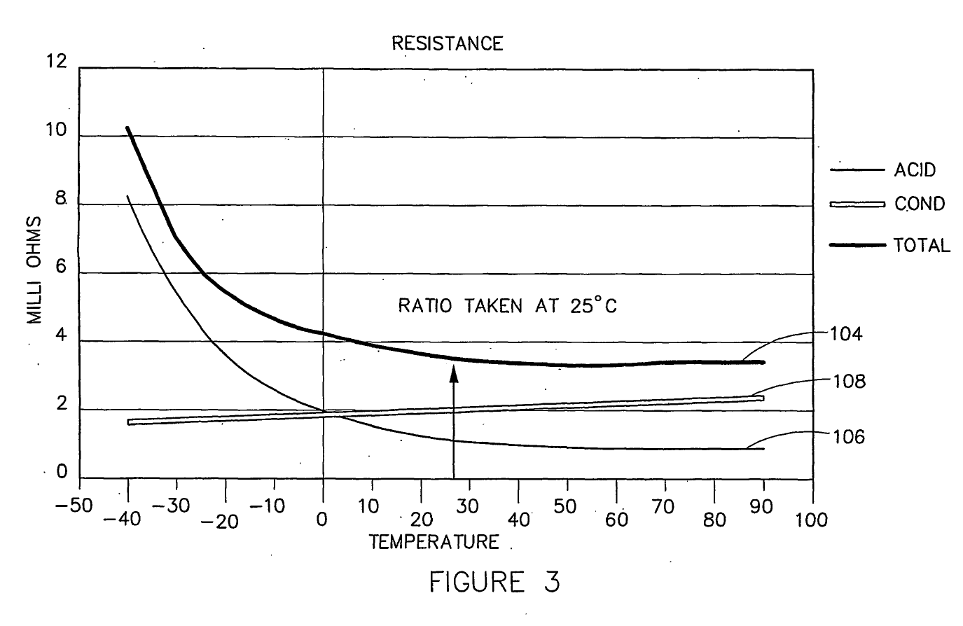

The ionic and electronic resistance components of a battery are shown in the graph of FIG. 3. The ratio of the ionic resistance 106 to conductor or electronic resistance 108 is taken at the 25 degrees C. temperature. The test for determining ionic and electronic resistance can vary by battery type or manufacturer. A typical test for determining these values comprises measuring the load voltage drop at certain temperatures, including −40 degrees C., −20 degrees C., 0 degrees C., 25 degrees C., and 50 degrees C. to determine the total resistance of the battery at varying temperatures. The resistance of the conductor can be obtained from handbooks such as the Handbook of Chemistry and Physics, provided by a battery manufacturer, or from other sources. The ionic or acid resistance of the battery may then be obtained by subtracting the conductor resistance from the total resistance.

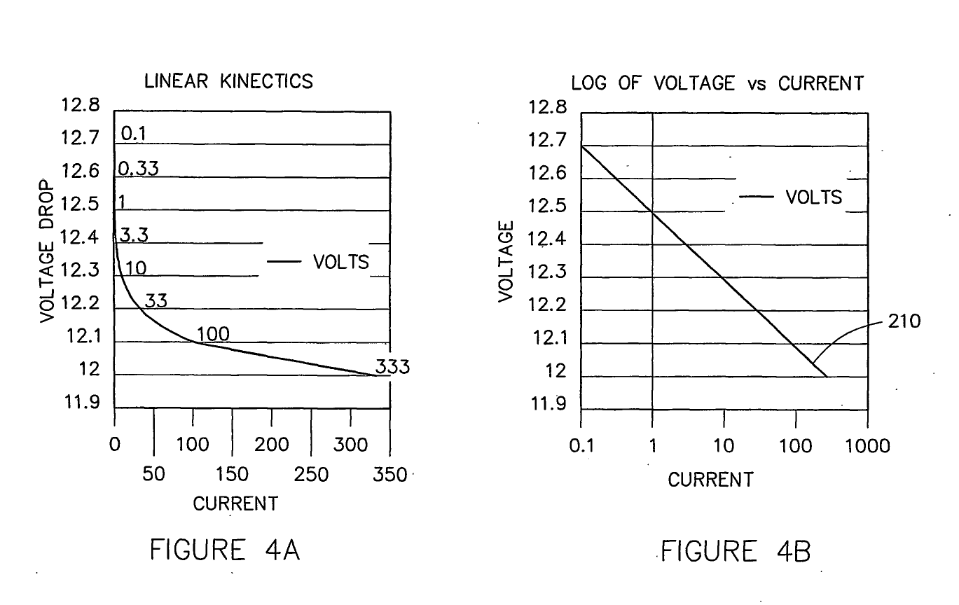

The kinetics (i.e. the expected kinetic voltage drop of the output of the battery due to the formation of lead sulfate) for a given battery is determined by discharging a fully charged battery at the twenty hour rate (i.e. twenty hours at four amps), the ten hour rate, and the two hour rate. The voltage drops are taken five minutes into the discharge. The resistive component (i.e. the voltage drop determined due to the determined internal resistance of the battery) is subtracted from the voltage of the fully charged battery. The change in voltage versus change in current (dv/di in FIG. 4A) is then plotted on log-log paper (see FIG. 4B) to determine the total internal resistance 210. The resistance component of a simulation circuit (see FIG. 7B) is constructed to account for kinetic voltage drop (i.e. the potential at which the battery resides at 10% state of charge of the battery). This potential at 10% state of charge is modeled as a capacitor according to a preferred embodiment. According to a preferred embodiment as shown in FIG. 7B, a resistive component comprising a MOSFET driven by a digital controller is used in conjunction with the capacitor and resistive elements to provide a more accurate curve.

To characterize the current delivery capability of the battery, an initial test is performed to determine the nominal capacity 18 (see FIG. 1). The nominal capacity relates to the battery's ability to deliver charge at the one hour rate (i.e. discharge for one hour at sixty amps). The nominal capacity can be determined by applying a number of tests known to those of skill in the art who review this disclosure. The nominal capacity provides a point to locate Peukert's slope 30 (see FIG. 1) for a given battery.

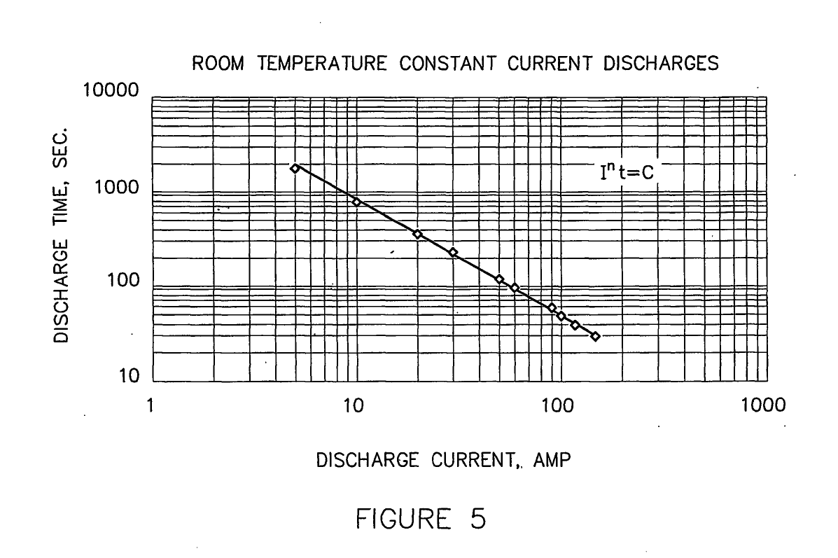

The measurement of the ability of a battery to deliver current at different rates is quantified in Peukert's slope. An example of Peukert's slope is shown in FIG. 5. The current delivery of a selected battery may be modeled by determining a known point (e.g., the nominal capacity) and the slope (from Peukert's equation) according to a preferred embodiment. The known point and the slope define the current characteristics for the battery, and hence for the model. Peukert's equation is:

I₁ⁿt₁=I₂ⁿt₂=C

where n and C are constants which can be determined by the battery manufacturer or which can be determined by calculating discharge at the one hour rate and at the twenty hour rate and using these values in the equation above as I₁t₁ and I₂t₂ respectively. Given the one hour rate determined as the nominal capacity, the slope of the discharge current can be calculated.

The voltage and state of charge parameters of the battery are characterized as a curve of the charged stable open circuit voltage (OCV) versus the relative state of charge (RSOC). These characteristics may also be used to characterize the deliverable power and deliverable energy of the battery according to an alternative embodiment. The tests for determining open circuit voltage and relative state of charge values are conducted as follows.

The charged stable open circuit voltage (OCV) relates to the open circuit voltage of the battery at equilibrium when charged and at rest with no load. The charged stable OCV is determined by charging a battery according to SAE J(537) standard, allowing the battery to sit for 24 hours, then discharging the battery at 25 amps for two minutes, according to a preferred embodiment. The OCV is read after the battery has rested for 30 minutes.

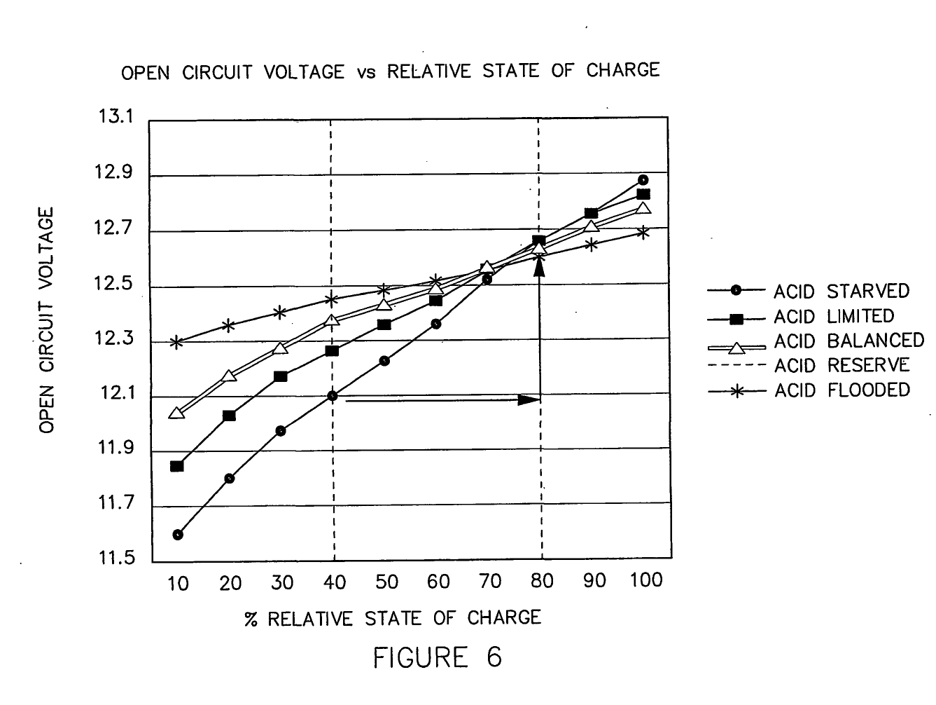

The OCV/RSOC slope is determined by discharging the battery at the 20 hour rate in 10% increments down to 10% of the total state of charge value. OCV readings are taken 30 minutes after each 10% discharge. The OCV is plotted and the slope is determined between 40 and 80% of total charge (see FIG. 6). This effect is modeled by charging capacitors, and may therefore be supplied by a combination of charging capacitors and associated resistors according to a preferred embodiment (see FIG. 7B). The effect can be modified through the use of MOSFETS, which can be selectively activated to add resistance to the circuit, thereby modifying the slope of the curve, and providing a more accurate simulation of an acid-starved or acid-flooded battery.

The thermal constant of the selected battery can be determined as a “black body” calculation based on zero air movement (e.g., for determining temperature characteristics of the battery). The thermal constant is based on the time it takes a battery to dissipate 10 degrees C. when a battery at a 60 degrees C. is placed in a 25 degrees C. environment according to a preferred embodiment. The thermal constant is modeled through the use of heat sinks on the components of the circuit according to a preferred embodiment (see FIG. 7B). Note that the thermal constant as modeled does not necessarily take into account air flow or other moderating or cooling effects on thermal performance, but may account for these factors according to alternative embodiments.

Given the battery characteristics and parameters, an equivalent circuit model having a transfer function that exhibits the charging and discharging characteristics of a selected battery can be constructed. Referring now to FIGS. 7A and 7B, a circuit diagram of an equivalent circuit model is shown. As shown in FIG. 7A, circuit 100 includes three functional blocks: (1) a double layer capacitance or initial charge circuit 111 for simulating the initial charge of the battery up to a predetermined base voltage (e.g., about 2.3 volts) at a predetermined slope; (2) an impedance or electrochemical simulation circuit 113 for simulating the impedance of the battery related to the electrochemical reactions of charging and discharging the battery above a base voltage level (e.g., about 11.7 volts); and (3) a circuit relating to the potential at which the battery resides at 10% state of charge (e.g., about 13 volts) or kinetic voltage drop circuit 115 for modeling the effects of the formation of lead sulfate, as exhibited as a capacitive charging effect on the outer surface of the plate or plates of the lead-acid battery.

Referring further to FIG. 7B, the initial charge circuit 111 includes a capacitor 174 and associated resistor 176 which form an RC (resistance capacitance) time constant circuit that charges rapidly to a base value, generally about 11.5 volts. The initial charge circuit models the initial charge (e.g., double layer capacitance) of a lead-acid battery, wherein the voltage rises rapidly in the first cell of the battery while the state of charge rises slowly. When the capacitor 174 is charged to the selected base value (e.g., 11.7 volts), a zener diode 180 limits the voltage across the capacitor 174 at the charged value. The base voltage value may be obtained by reference to the RSOC v. OCV graph of the battery (see FIG. 6).

Referring still to FIG. 7B, the voltage drop circuit 115 comprises an RC circuit having a capacitor (shown as a kinetic capacitor 134), and a resistor (shown as resistor 110 and resistor 122). The kinetic capacitor 134 and associated resistor 122 combine to simulate the capacitive charging which occurs on the surface of the outer plate of the battery due to the reaction to form lead sulfate, and may be exhibited as a logarithmic drop due to the rate at which lead crystals form in the battery. The slope of the curve associated with the capacitive charging can vary with time and temperature. These effects are simulated through the addition of a device or switch (shown as a MOSFET 188) which couples additional resistors to the circuit as commanded by a control system (not shown) which can, for example, be programmed with experimentally determined data relating to time and temperature effects on a selected lead-acid battery. The values of components for this circuit for simulating a selected battery can be determined with reference to the kinetic voltage testing (see FIGS. 4A and 4B).

The electrochemical simulation circuit 113 of FIG. 7B includes an RC network modeling the impedance of the battery. The electrochemical simulation circuit includes resistors for simulating the internal resistance of the battery and capacitors for simulating the charging and discharging of the battery due to internal chemical reactions. The electrochemical simulation circuit 113 comprises a plurality of resistors 110, 112,114, 116, 118 and 120 (the “acid resistors”) which model the ionic or acid resistance of the battery, and a plurality of resistors 122, 124, 126, 128, 130, 132, 136, 138, 140, 142 and 144 (the “conductor resistors”) which combine to model the resistance due to the electronic component in the battery. Together, these resistors sum to provide the overall total resistance of the battery (see FIGS. 2 and 3).

The acid resistors act as negative temperature coefficient (NTC) resistors, which drop in resistance as the temperature increases, according to a preferred embodiment. The NTC resistors account for the differing effects of heat on the acid and conductive resistance in the circuit (see FIG. 3). The chemical component of the overall battery resistance generally decreases when heat is applied, while the conductive component generally increases when heat is applied. Although in most applications, standard carbon film or other types of resistors known to those skilled in the art who review this disclosure can be used for the conductor resistors, in some applications the conductor resistors can be modeled with positive temperature coefficient (PTC) resistors which increase in resistance as heat is applied.

The capacitors 164, 166, 168, 170 and 172 assist in accounting for the faradic effect (or the chemical reaction of materials in the battery) while the resistors 156, 158,160 and 162 are diffusion resistors which help to charge the faradic capacitors evenly. The capacitors 164, 166, 168, 170 and 172 generally simulate the layers of plates inside the lead-acid battery being simulated. The capacitor 164 represents the outside layer of the plate or plates, and the capacitor 172 represents the inside layer. The final voltage value of the faradic capacitors may also be limited by a zener diode 184 and associated limiting resistor 182. The zener diodes 180 and 184 combine to determine the “charged voltage,” or open circuit voltage (OCV) at equilibrium with no load (e.g., about 13.1 volts DC). The rate of charge and discharge of these circuits, as well as the open circuit voltage value, is determined based on the Peukert's Equation calculation and OCV versus RSOC curves (see FIGS. 4A, 4B and 5).

The total capacitance of the circuit is calculated based on the rated number of amp hours in the circuit, wherein each farad of capacitance is equivalent to one amp-second. For a 60 amp hour battery, for example, 21,600 Farads of capacitance may be required. The number of capacitors between the outside capacitor 162 and inside capacitor 172 depends in part on the construction of the battery being simulated, and particularly on the thickness of the plates used. For example, a battery constructed of thin plates will generally charge and discharge rapidly, and therefore fewer capacitors may be needed to simulate this effect. In a battery constructed with thick plates, however, charge and discharge will occur over a longer time period. Therefore, in this application, a relatively larger number of capacitors may be used. The magnitude of the capacitors is determined by the transfer function. For example, based on the amp hour capacity (i.e., nominal capacity) of the battery and Peukert's slope, the magnitude (i.e., size) of capacitors 164, 166, 168, 170 and 172 are sized. A relatively gradual Peukert's slope of the battery will result in a relatively high magnitude capacitor 164 and a relatively low magnitude capacitor 172. A relatively steep Peukert's slope of the battery will result in a relatively low magnitude capacitor 164 and a relatively high magnitude capacitor 172.

Although an embodiment of an RC impedance circuit for the electrochemical simulation circuit has been shown and described, it will be apparent to those skilled in the art who review this disclosure that a number of different representations of the impedance of battery cells can be employed. Various methods of measuring impedance of battery cells and of simulating the impedance with resistive, capacitive and inductive elements can be employed.

In operation, the capacitor 174, the faradic capacitors, and the kinetic capacitor 134 combine to model the charging slope of the OCV versus RSOC curve of the battery and the current delivery of the circuit as defined by Peukert's slope, the Nernst equation, and the nominal capacity. When a voltage is applied to the circuit between terminals 190 and 192, the capacitor 174 initially charges at a predetermined rate until the base voltage level is met. At this point, the voltage on the capacitor 174 may be “capped” or limited by the zener diode 180. The smaller faradic capacitors then charge at a slow rate, modeling the effect in a lead-acid battery as the internal cells slowly charge due to the chemical conversion of materials. This voltage gain may again be “capped” or limited by the zener diode 184, which prevents charge above the open circuit voltage of the battery being simulated. The kinetic resistance (e.g., voltage drop due to the reaction to form lead sulfate) is modeled by the capacitor 134, which adds an additional slope to the charging and discharging capacitive circuit described above. A discharge resistor 186 is included in the circuit for discharging all of the capacitors in the circuit according to a preferred embodiment.

On discharge, the faradic capacitors and the kinetic capacitor 134 again initially discharge slowly. The capacitor 174 is prevented from discharging until the voltage across the zener diode 180 falls below the selected base voltage. Discharge, therefore, models the discharge of the simulated battery.

The effects of temperature and time on the kinetics of the circuit can be modified by the addition of devices (e.g., MOSFETS) to the circuit. The MOSFET 188 may be used to vary resistance to the model, thereby decreasing the slope of the curve caused by the kinetic capacitor 134 and associated resistors. The faradic effect can also be modified by the addition of MOSFETS 146, 148, 150, 152 and 154 that can be selectively activated to increase the resistance in the RC circuits. According to any preferred or alternative embodiment, the MOSFET devices are driven by a control system such as a computer, microprocessor, or microcontroller which can be programmed to vary the resistance based on experimentally determined time and temperature effects on a given lead-acid battery.

The simulation circuit shown and described simulates the operation of a battery, and includes a portrayal of the OCV and RSOC curve. Because of the capacitors in the circuit model, the expected RSOC versus OCV, the logarithmic drop in the slope based on the Nernst equation, and the current capacity (Peukert's slope), the charging and discharging of the battery simulation circuit model that of an actual battery. Because the battery simulation circuit (e.g., “simulator”) models the charge and voltage characteristics of the battery, and particularly the rates of charging and discharging, it can also model the deliverable power and deliverable energy of the battery.

Furthermore, the output of the circuit can be modified to mimic or model time and temperature effects on the circuit through the use of resistance varying devices such as MOSFETS, transistor elements, solid state switches in conjunction with resistive elements, or in other ways known to those skilled in the art who review this disclosure. The effects of time and temperature are preferably modeled by a programmable device which can store tabular or other data related to a number of effects according to a preferred embodiment. Such a device, for example, can be used to switch additional capacitance and resistance into a circuit.

Based on the test and characterization parameters, the following parameters can be used to characterize the battery:

(1) Total Resistance in milliohms

(2) Ratio of ionic/electronic resistance

(3) Kinetics

(4) Peukert's slope

(5) Nominal Capacity

(6) Charge voltage

(7) OCV/RSOC slope

(8) Thermal Constant

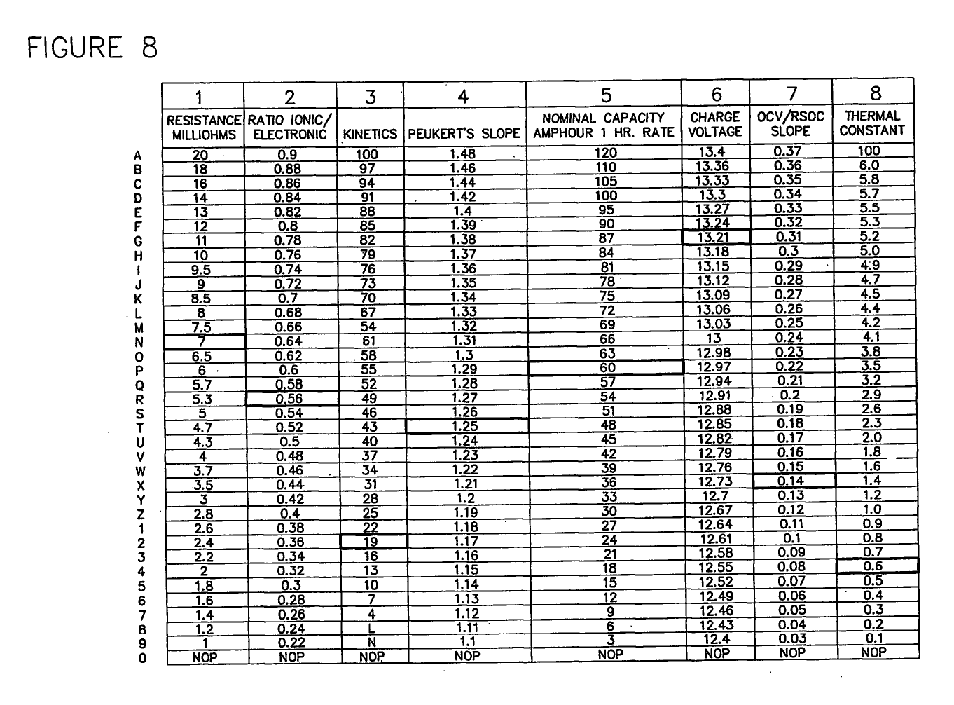

These characteristics can be coded into a universal code word or product code which can be located on a display (e.g., label, electronic chip in or associated with the battery, etc.). A sample code is shown in FIG. 8. The display can provide information relating to testing of a battery. An electronic version of the code can be read directly by a controller, such as the controller of a vehicle, and decisions regarding battery usage may be made based on the expected characteristics of the battery. A second code can be established to provide charging and life information for a battery during use. It will be apparent to those skilled in the art who review this disclosure that the data used for characterizing the battery can be formatted in a number of different ways, and that varying of modeling accuracy can be achieved by including one or more of the characteristics of the battery.

The universal product code may provide sufficient information for a user to select an appropriate replacement for a vehicle, or for another application having a lead-acid battery. The universal product code can supply a total characterization of a battery to an intelligent controller. The controller, therefore, can make informed decisions regarding the charge state of a battery, possible overheating and overloading conditions, and potential failure. Such information can be provided to drivers as an indication that service may be needed. The system and method may provide the ability to monitor the charge state of the battery in battery-operated and hybrid vehicles.

The controller may be a microprocessor, programmable logic chip (PLC), or other controller for implementing a control program and which provides output signals based on input signals provided by an sensor or that are otherwise acquired. According to alternative embodiments, other suitable controllers of any type may be included in the control system. For example, controllers of a type that may include a microprocessor, microcomputer, or programmable digital processor, with associated software, operating systems and/or any other associated programs to collectively implement the control program may be employed. According to alternative embodiments, the controller and its associated control program may be implemented in hardware, software, or a combination thereof, or in a central program implemented in any of a variety of forms.

The battery characterization system can be implemented as a simulation model through any combination of hardware devices (e.g., circuits, MOSFETs, capacitors, resistors) or software (e.g., SPICE or other software simulation programs). According to a preferred embodiment, the various “circuits” of the system (e.g., charging circuit, electrochemical reaction circuit, voltage drop circuit, etc.) may be implemented with software routines or models configured to simulate or model the performance of a circuit representative of a particular battery (or type of battery). For example, the various representative circuits may include values that are programmed or are adjusted (e.g., within the operation of a control or software program) to simulate the performance or function of the actual circuit devices (e.g.,(in place of a hardware resistor, the system may include a resistor value that may be used in various calculations designed to model or simulate the function of the resistor). A program used according to a particularly preferred embodiment of the system will allow the simulation of a representative circuit that will approximate the performance of an actual battery of a particular type (e.g., simulate representative output values in response to input values). The number of hardware components within the model or representative circuit required may be adjusted within the software-based simulation model. The software model may be configured to run on any of a variety of computing devices (e.g., microprocessors, controllers, computers, etc.) and may be written in a variety of programming languages.

It is important to note that the construction and arrangement of the elements of the battery characterization method and simulation model as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited herein. For example, although an exemplary embodiment of an equivalent circuit model for a lead-acid battery has been shown and described, it will be apparent that variations can be made. Further, although one RC network has been shown for simulating the electrochemical charging and discharging effects of the circuit, other models will be understood to those skilled in the art who review this disclosure. RC network circuits can include, for example, RC ladder, transmission line simulation circuits, and RCL circuits which further include inductive elements. Furthermore, although certain charging and discharging circuits have been shown and described, it will be apparent to those skilled in the art who review this disclosure that the functions provided by these circuits could be constructed in various ways using various circuit elements with similar results. Other variations to the circuits can also be made by those skilled in the art who review this disclosure. Additionally, although a series of tests for characterizing the battery has been shown and described, alternate methods of determining various battery characteristics and related curves will be apparent to those skilled in the art who review this disclosure. Furthermore, it will be apparent that battery simulations can be constructed with varying accuracy by performing a subset of the described tests and constructing a simulation circuit based on the results. Accordingly, all such modifications are intended to be included within the scope of the present inventions. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present inventions.

What is claimed is:

1. A system for modeling a lead-acid battery in the form of a representative electrical circuit comprising:
an electrical circuit comprising:
a charging circuit configured to simulate the initial charging of the battery and having a capacitor configured for charging to a first voltage;
an electrochemical reaction circuit comprising:
a plurality of capacitors configured to simulate the charging and discharging of the battery due to internal chemical reactions and configured for charging to a second voltage;
a plurality of resistors for simulating the resistance of the battery;
a voltage drop circuit including a resistor and a capacitor configured to simulate capacitive charging and discharging of the battery and configured for charging to a third voltage;
wherein the representative circuit is implemented through a computer-based simulation.

2. The system of claim 1 wherein the first voltage is at least about 11 volts, the second voltage is at least about 2 volts, and the third voltage is at least about 13 volts.

3. The system of claim 1 wherein the charging circuit includes a double layer capacitance circuit.

4. The system of claim 2 wherein the charging circuit includes a diode for limiting the charge across the capacitor of the charging circuit.

5. The system of claim 3 wherein the electrochemical reaction circuit comprises an RC ladder.

6. The system of claim 5 wherein a first resistor of the plurality of resistors simulates an electrical resistance of the battery.

7. The system of claim 6 wherein a second resistor of the plurality of the resistors simulates an ionic resistance of the battery.

8. The system of claim 7 wherein the second resistor comprises at least one of a positive temperature coefficient resistor and a negative temperature coefficient resistor.

9. The system of claim 6 wherein a first capacitor of the plurality of capacitors simulates an outside layer of a plate of the battery.

10. The system of claim 9 wherein a second capacitor of the plurality of capacitors simulates an inside layer of a plate of the battery.

11. The system of claim 10 further comprising a device for simulating a slope of the open circuit voltage of the battery versus the relative state of charge of the battery due to at least one of time and temperature.

12. The system of claim 11 wherein the device comprises a MOSFET.

13. A system for modeling a lead-acid battery in the form of a representative electrical circuit comprising:
an electrochemical reaction circuit configured to simulate the charging and discharging of the battery between a predetermined base voltage and a predetermined open circuit voltage;
a charging circuit configured to charge the electrochemical reaction circuit to the base voltage;
wherein the representative circuit is implemented through a software-based simulation.

14. The system of claim 13 further comprising a voltage drop circuit configured to simulate the effects of the formation of lead sulfate in the battery.

15. The system of claim 14 wherein the charging circuit comprises a capacitor and a resistor electrically coupled in parallel.

16. The system of claim 15 wherein the capacitor and resistor provide a charging slope to the base voltage.

17. The system of claim 16 wherein the electrochemical reaction circuit comprises an RC ladder network.

18. The system of claim 16 wherein the RC ladder network includes a first resistor for simulating an ionic component of an internal resistance of the battery and a second resistor for simulating an electronic component of the internal resistance of the battery.

19. The system of claim 18 wherein the voltage drop circuit comprises a resistor and a capacitor.

20. An equivalent circuit model of a battery comprising an impedance circuit model for simulating the electrochemical charging and discharging of the battery, an improvement comprising:
an initial charge circuit model for charging the equivalent circuit model to a predetermined voltage value.

21. The equivalent circuit model of claim 20 further comprising an electrochemical reaction circuit model comprising a plurality of capacitor models for simulating the charging and discharging of the battery due to chemical reactions and a plurality of resistor models for simulating the impedance of the battery.

22. The equivalent circuit model of claim 21 further comprising a voltage drop circuit model including a capacitor model and a resistor model for modeling capacitive charging and discharging of the battery.

23. A circuit for modeling a lead-acid battery having an RC network for simulating the impedance of the battery, an improvement comprising:
a charge circuit comprising a capacitor, a resistor, and a diode each electrically coupled in parallel, the charge circuit being electrically coupled to the RC network for charging the circuit to a base voltage;
wherein the RC network charges the circuit between the base voltage and an open circuit voltage to simulate the electrochemical charging of the battery.

24. The circuit of claim 23 wherein the RC network comprises at least one MOSFET for charging and discharging a plurality of capacitors of the RC network.

25. The circuit of claim 24 further comprising a programmable device to selectively activate and deactivate the at least one MOSFET.

26. The circuit of claim 25 wherein the programmable device is programmed to model the effect of time and temperature on the circuit.

27. The circuit of claim 26 wherein the base voltage is at least about 11 volts.

28. The circuit of claim 23 wherein the circuit is simulated using numerical values programmed in a computer-based simulation model.

29. A method of modeling a lead-acid battery with an electrical circuit comprising a charging circuit, an electrochemical reaction circuit, and a voltage drop circuit, comprising:
charging a capacitor of the initial charging circuit at a predetermined rate to a predetermined voltage, thereby simulating the initial charging of the battery;
charging and discharging a plurality of capacitors of the electrochemical circuit, thereby simulating a slope of an open circuit voltage of the battery versus a relative state of charge of the battery;
charging and discharging a capacitor of the voltage drop circuit, thereby simulating a capacitive charging and discharging of the battery.

30. The method of claim 29 further comprising limiting the charging of the capacitors with a diode.

31. The method of claim 30 further comprising selectively electrically coupling a MOSFET to the electrochemical circuit, thereby simulating the effects of time and temperature.

32. A battery characterization system implemented through a control program comprising a representative circuit, the battery characterization system comprising:
a model of a representative electrical circuit comprising:
a model of a representative charging circuit configured to simulate the initial charging of the battery and having a capacitor model configured to simulate charging to a first voltage;
a model of a representative electrochemical reaction circuit comprising:
a plurality of capacitor models configured to simulate the charging and discharging of the battery due to internal chemical reactions and configured to simulate charging to a second voltage;
a plurality of resistor models for simulating the resistance of the battery;
a model of a representative voltage drop circuit including a resistor model and a capacitor model configured to simulate capacitive charging and discharging of the battery and configured for simulating charging to a third voltage;
wherein the battery characterization system is implemented through a computer-based simulation.

33. The battery characterization system of claim 32 wherein the first voltage is at least about 11 volts, the second voltage is at least about 2 volts, and the third voltage is at least about 13 volts.

34. The battery characterization system of claim 32 wherein the model of a representative charging circuit comprises a double layer capacitance circuit model.

35. The battery characterization system of claim 32 wherein the model of a representative charging circuit includes a diode model for limiting the charge across the capacitor model of the charging circuit.

36. The battery characterization system of claim 32 wherein the computer-based simulation comprises software configured to run on at least one of a controller, a computer, and a microprocessor.

37. The battery characterization system of claim 32 one the plurality of the resistor models simulates an ionic resistance of the battery and another of the plurality of resistor models simulates an electrical resistance of the battery.

38. The battery characterization system of claim 32 further comprising means for simulating a slope of the open circuit voltage of the battery versus the relative state of charge of the battery due to at least one of time and temperature.

39. A method for making an equivalent electrical circuit model of a lead-acid battery comprising:
determining Peukert's slope for the battery;
determining the nominal capacitance of the battery;
selecting a plurality of capacitors for the electrical circuit model based on the Peukert's slope and the nominal capacitance of the battery.
